(19) United States
(12) Patent Application Publication
(10) Pub. No.: US 2015/0277256 A1
(43) Pub. Date: Oct. 1, 2015

(54) FERRITE CARRIER CORE MATERIAL FOR ELECTROPHOTOGRAPHIC DEVELOPER, FERRITE CARRIER AND ELECTROPHOTOGRAPHIC DEVELOPER USING THE FERRITE CARRIER

(71) Applicant: POWDERTECH CO., LTD., Kashiwa-shi (JP)

(72) Inventors: Hiroki SAWAMOTO, Kashiwa-shi (JP); Hiromichi KOBAYASHI, Kashiwa-shi (JP)

(21) Appl. No.: 14/671,710

(22) Filed: Mar. 27, 2015

(30) Foreign Application Priority Data
Mar. 27, 2014 (JP) 2014-065724

(51) Int. Cl. G03G 9/113; C01G 49/00; H01F 1/01; G03G 9/10

(52) U.S. Cl. CPC G03G 9/1133; G03G 9/10; C01G 49/0072; H01F 1/01; C01P 2004/61; C01P 2004/90; C01P 2006/42

(57) ABSTRACT

There is provided a ferrite carrier core material for an electrophotographic developer, which includes ferrite particles. A volume average particle diameter of the ferrite particles is from 10 μm to less than 20 μm. Also, there is provided a ferrite core which includes the ferrite carrier core material, and a resin coating a surface of the ferrite carrier core material. Further, there is provided an electrophotographic developer which includes the ferrite carrier; and a toner, wherein a concentration of the toner is from 15 to 35 wt %.

### CROSS-REFERENCE TO RELATED APPLICATION

This application claims priority from Japanese Patent Application No. 2014-065724, filed on Mar. 27, 2014, the entire subject matter of which is incorporated herein by reference.

### TECHNICAL FIELD

The present invention relates to a ferrite carrier core material for an electrophotographic developer, which is intended for a two-component electrophotographic developer used in a copying machine, a printer, etc.; a ferrite carrier; and an electrophotographic developer using the ferrite carrier. More specifically, the present invention relates to a ferrite carrier core material for an electrophotographic developer, which is excellent in the charge imparting ability even at a high toner concentration and exhibits a good mixing property with a toner; a ferrite carrier; and an electrophotographic developer using the ferrite carrier.

### BACKGROUND ART

An electro photographic developing method is a method of developing an electrostatic latent image formed on a photoreceptor by adhering thereto a toner particle in a developer, and the developer used in this method is classified into a two-component developer composed of a toner particle and a carrier particle, and a one-component developer using only a toner particle.

As the developing method using, out of these developers, a two-component developer composed of a toner particle and a carrier particle, a cascade method, etc. has long been employed, but a magnetic brush method using a magnet roll is currently the mainstream.

In a two-component developer, the carrier particle is a carrier substance which is stirred together with a toner particle in a development box filled with the developer to impart a desired charge to the toner particle and further transports the charged toner particle to the surface of a photoreceptor to form a toner image on the photoreceptor. A carrier particle remaining on a magnet-holding development roll is again returned to the development box from the development roll, mixed/stirred with a fresh toner particle, and used repeatedly for a given period or time.

In a two-component developer, unlike a one-component developer, a carrier particle is mixed and stirred with a toner particle to exert a function of charging the toner particle and transporting the toner particle and exhibits good controllability when designing a developer. Therefore, the two-component developer is suitable for apparatuses such as a full-color development apparatus requiring high image quality and a high-speed printing apparatus requiring reliability and durability in image preservation.

In a two-component developer used in this way, it is necessary that image characteristics such as image density, fogging, white spot, gradation and resolution show predetermined values from the initial stage and moreover, these characteristics are stably maintained throughout the printing life without variation. In order to stably maintain these characteristics, the carrier particle contained in the two-component developer must be stable in its properties.

As the carrier particle forming a two-component developer, an iron powder carrier, such as iron powder with the surface being covered by an oxide coating and iron powder with the surface being resin-coated, has been conventionally used. Such an iron powder carrier has a high magnetization and a high electrical conductivity and therefore, is advantageous in that an image with good reproducibility of a solid portion is likely to be obtained.

However, such an iron powder carrier has a true specific gravity as heavy as about 7.8 and has a too high magnetization and therefore, its stirring/mixing with a toner particle in a development box readily involves fusion of a toner-constituting component onto the iron powder carrier surface, so-called toner spent. Generation of the toner spent leads to a decrease in the effective carrier surface area, and the triboelectric charging performance with a toner particle is liable to be deteriorated.

In a resin-coated iron powder carrier, the resin on the surface may separate due to a stress during endurance, and a core material (iron powder) having a high electrical conductivity and a low dielectric breakdown voltage may be exposed to cause leakage of an electric charge. Such leakage of an electric charge may result in breaking an electrostatic latent image formed on a photoreceptor and generating a brush streak, etc. in the solid portion, as a result, a uniform image can be hardly obtained. For these reasons, an iron powder carrier such as oxide-coated iron powder and resin-coated iron powder is not used at present.

In recent years, instead of an iron powder carrier, a resin-coated ferrite carrier where a ferrite having a true specific gravity as light as about 5.0 and having a low magnetization is used as a ferrite carrier core material and the surface thereof is coated with a resin, is often used, and the life of the developer is remarkably extended.

However, with the recent progress of office networking, the age of monofunctional copier evolves into the age of multifunctional copier, and the service system is also shifted from the age of system where a contracted service man performs periodic maintenance inclusive of replacement of a developer, etc., to the age of maintenance-free system, which is accompanied by an increase in the market demand for a further longer life of the developer.

In the office, a full-color image is recognized and with an increasing demand for a further higher image quality, the toner particle diameter also becomes a small particle diameter so as to obtain high resolution.

To cope with this, the carrier particle diameter is also shifting toward the direction of a small particle diameter and a high specific surface area, because the toner must be quickly charged to a desired charge. When the overall particle size distribution is shifted to a small particle diameter, a phenomenon that particles, among others, in the fine powder side dusting or adhere to the photoreceptor, so-called beads carry over is likely to occur, and a critical image defect such as white spot is readily induced. Therefore, as regards the carrier having a small particle diameter, it is also required to control the particle size distribution width to be further narrower.

Patent Document 1 (JP-A-H7-98521) discloses an electrophotographic carrier having a 50% average particle diameter of 15 to 45 μm and having a specified surface area. This carrier is a carrier with a uniform small particle diameter, where the average particle diameter is small and the abundances of fine powder and coarse powder are controlled to make the particle size uniform, and at the same time, this is a carrier where a certain degree of unevenness is imparted to the surface. Therefore, the carrier is characterized in that the toner transporting property is good and the rise of triboelectric charging with a toner is also successfully improved.

However, the surface property of the carrier described in Patent Document 1 cannot impart a sufficient charging ability in the recent high-speed high-rate printing apparatus. In addition, although an average particle diameter of 15 to 45 μm is disclosed, the average particle diameter is mostly about 35 μm in Examples of Patent Document 1, where even a smallest average particle diameter is, for example, about 25 μm at most, and a carrier of 10 to 20 μm is not substantially disclosed. Furthermore, as for the toner concentration, only an example of up to about 9% is disclosed, and use at a high toner concentration is not envisaged.

Patent Document 2 (JP-B-5,333,882) discloses a carrier for an electrophotographic developer, where the weight average particle diameter is from 22 to 50 μm, the shape factor SF-1 is from 100 to 120, and the shape factor SF-2 is from 100 to 200. In Patent Document 2, it is said there can be provided: a carrier having a small particle diameter, a specific particle diameter distribution such that the content ratio of a particle having a small particle diameter is low, a nearly true spherical particle shape and a smooth surface, which is a carrier where by virtue of controlling the ratio of a particle having, inside of a core material, a hollow not smaller than a certain size, the granularity is good, the film is hardly abraded, the charge amount is prevented from reduction, the spent is little caused owing to spherical shape, the background scumming is decreased, and the beads carry over is less likely to occur; a developer; a developing method; and an image forming method.

However, when the average particle diameter of the carrier is about 22 μm, a sufficient charging ability cannot be imparted in a recent high-speed high-rate printing apparatus. In addition, as described in claim 1 of Patent Document 2, use at a toner concentration of about 7% at most is a limit for such a carrier.

Patent Document 3 (JP-B-3,029,180) discloses a resin-coated ferrite carrier for an electrophotographic developer, where the number average particle diameter is from 20 to 50 μm and the average value of the long axis/short axis ratio is from 1.00 to 1.20. Furthermore, in Patent Document 3, a method of spraying a flare by using a combustion gas and oxygen is disclosed as the production method of the carrier. In Patent Document 3, it is stated that the carrier has a good degree of sphericity and a good average particle diameter, the standard deviations thereof are small and when formed into a developer together with a toner, the rise of charging is greatly improved.

However, the resin-coated ferrite carrier described in Patent Document 3 cannot impart a sufficient charging ability in the recent high-speed high-rate printing apparatus.

### SUMMARY

Accordingly, an object of the present invention is to provide a ferrite carrier core material for an electrophotographic developer, which is excellent in the charge imparting ability even at a high toner concentration and exhibits a good mixing property with a toner; a ferrite carrier; and an electrophotographic developer using the ferrite carrier.

As a result of intensive studies, the present inventors have found that the above-described object can be attained by using, as a ferrite carrier core material, a ferrite particle having a very small average particle diameter and having a true spherical shape with little surface unevenness. The present invention has been accomplished based on this finding.

That is, the present invention provides a ferrite carrier core material for an electrophotographic developer, which includes ferrite particles, wherein a volume average particle diameter of the ferrite particles is from 10 μm to less than 20 μm.

In the ferrite carrier core material for an electrophotographic developer according to the present invention, a shape factor SF-1 of the ferrite particles may be preferably from 100 to 120.

In the ferrite carrier core material for an electrophotographic developer according to the present invention, a shape factor SF-2 of the ferrite particles may be preferably from 100 to 120.

The present invention also provides a ferrite carrier for an electrophotographic developer, obtained by coating the surface of the above ferrite carrier core material with a resin.

Furthermore, the present invention provides an electrophotographic developer including the above ferrite carrier and a toner, wherein a concentration of the toner is from 15 to 35 wt %.

In the ferrite carrier core material for an electrophotographic developer according to the present invention, a ferrite particle having a very small average particle diameter and having a true spherical shape with little surface unevenness is used, so that when a ferrite carrier obtained by coating the surface of the ferrite carrier core material with a resin is formed into a developer together with a toner, the charge imparting ability is excellent even at a high toner concentration and because of high flowability, the mixing property with a toner is good.

### BRIEF DESCRIPTION OF THE DRAWINGS

The above and other aspects of the present invention will become more apparent and more readily appreciated from the following description of illustrative embodiments of the present invention taken in conjunction with the attached drawings, in which:

FIG. 1 is an electron micrograph (secondary electron image, ×450) of the ferrite carrier core material of Example 1;

FIG. 2 is an electron micrograph (secondary electron image, ×450) of the ferrite carrier core material of Comparative Example 1; and

FIG. 3 is an electron micrograph (reflected electron image, ×450) of the ferrite carrier of Example 4.

### DETAILED DESCRIPTION

<Ferrite Carrier Core Material for Electrophotographic Developer and Ferrite Carrier>

The ferrite carrier core material for an electrophotographic developer according to the present invention is composed of a ferrite particle.

The ferrite particle used here preferably contains at least one member selected from Mn, Mg, Li, Ca, Sr, Cu, Zn and Ni. Considering the recent trend toward reduction of an environmental impact, including waste regulations, it is preferred not to contain heavy metals of Cu, Zn and Ni in excess of the incidental impurity level.

The volume average particle diameter of the ferrite particle used as the ferrite carrier core material for an electrophotographic developer according to the present invention is from 10 μm to less than 20 μm. In this way, the volume average particle is small and since the specific surface area is by far larger than that of the conventional carrier, the charge imparting ability is excellent. Therefore, even in a use mode involving an increase in the toner consumption, such as high-speed printing of a full color image, the toner continuously replenished can be quickly charged. In addition, the toner can be sufficiently charged even at a high toner concentration and in turn, even when the toner concentration is varied, an uncharged toner or a low charged toner is less likely to be generated, leading to no occurrence of a trouble such as toner dusting or fogging.

If the volume average particle diameter of the ferrite particle is less than 10 μm, the magnetization of one particle is excessively reduced to increase a fear of beads carry over. If the volume average particle diameter of the ferrite particle exceeds 20 μm, the specific surface area becomes small and in turn, the charge imparting ability cannot be sufficiently exerted.

[Volume Average Particle Diameter and Number Average Particle Diameter]

The volume average particle diameter is measured as follows. That is, the volume average particle diameter is measured using a Microtrac particle size analyzer (Model MT3300EXII) manufactured by Nikkiso Co., Ltd. Water is used as the dispersion medium. After putting 10 g of a sample and 80 ml of water in a 100-ml beaker, a few drops of a dispersant (sodium hexametaphosphate) are added, and the resulting mixture is dispersed for 20 seconds by using an ultrasonic homogenizer (model UH-150, manufactured by SMT Co., Ltd.) set to an output level of 4. Thereafter, the bubbles formed on the surface of the beaker are removed, and the sample is charged into the apparatus. The measurement mode in computation is set to HRA Model.

In this Microtrac, the particle diameter on the volume basis is measured, and the number average particle diameter is automatically computed from the measured value. The relationship between the volume average particle diameter and the number average particle diameter is generally as follows.

Volume average particle diameter=Σ(vi·di)/Σ(vi)

Number average particle diameter={Σ(vi)/di²}/{Σ(vi)/di³} [Expression 1]

wherein vi represents a representative particle diameter (μm), and di represents a volume of the particle having each representative particle diameter vi.

The shape factor SF-1 (circularity) of the ferrite particle used as the ferrite carrier core material for an electrophotographic developer according to the present invention is preferably from 100 to 120. The problem involved in making the ferrite carrier core material (ferrite particle) to have a small particle diameter is an extreme deterioration of the flowability of the carrier and developer. However, due to a shape close to a true sphere, despite a small particle diameter, the flowability is very good. In turn, the carrier is quickly mixed with a toner, and the rise characteristics of charging are improved. In addition, partialization is hardly caused in the developing machine, and uniform development can be achieved.

The shape factor SF-1 of a ferrite particle having a completely true spherical shape is 100. If the shape factor SF-1 of the ferrite particle exceeds 120, the flowability deteriorates.

The shape factor SF-2 (roundness) of the ferrite particle used as the ferrite carrier core material for an electrophotographic developer according to the present invention is preferably from 100 to 120. The factor affecting the flowability includes surface unevenness of the particle. The surface unevenness of the ferrite particle used as the ferrite carrier core material in the present invention is fine. Deep unevenness causes deterioration of the flowability.

When the surface is completely free of unevenness, the shape factor SF-2 of the ferrite particle is 100. If the shape factor SF-2 of the ferrite particle exceeds 120, the flowability deteriorates.

[Shape Factor SF-1 and Shape Factor SF-2]

The shape factor SF-1 and shape factor SF-2 of the particle are a value obtained by photographing an image of the ferrite particle in a 450-fold visual field by means of FE-SEM (SU-8020, manufactured by Hitachi High-Technologies Corp.), analyzing the image information introduced into an image analysis software (Image-Pro PLUS) produced by Media Cybernetics Corp. through an interface, determining Area (projected area), equivalent-circle diameter and projected peripheral length, and performing the calculation according to the following equation.

(Shape Factor SF-1)

The shape factor SF-1 (circularity) is a numerical value obtained by determining Area (projected area) and Feret diameter (maximum) and performing the calculation according to the following equation. As the shape of the ferrite particle is closer to a sphere, the value is closer to 100. The shape factor SF-1 is calculated for every one particle, and the average value of 100 particles is defined as the shape factor SF-1 of the carrier.

SF-1=(R²/S)×(π/4)×100 [Expression 2]

wherein R: equivalent-circle diameter, and S: Area (projected area).

(Shape Factor SF-2)

The shape factor SF-2 (roundness) is a numerical value obtained by dividing the square of a projected peripheral length of the ferrite particle by a projected area of the ferrite particle, dividing the resulting value by 4π, and multiplying the quotient by 100. As the shape of the carrier is closer to a sphere, the value is closer to 100. The shape factor SF-2 (roundness) is measured according to the following equation. The shape index SF-2 is calculated for every one particle, and the average value of 100 particles is defined as the shape factor SF-2 of the carrier.

SF-2=L²/S/4π×100 [Expression 3]

wherein L represents a projected peripheral length, and S represents a projected area.

In the ferrite carrier for an electrophotographic developer according to the present invention, the surface of the above-described ferrite carrier core material is coated with a resin. The carrier characteristics, among others, the electrical characteristics including charging characteristics, are in many cases affected by the material existing in the carrier surface or the properties.

The coating resin used here may be appropriately selected according to the toner combined, the use environment, etc. The coating resin is not particularly limited in its kind but includes, for example, fluororesin, acrylic resin, epoxy resin, polyamide resin, polyamideimide resin, polyester resin, unsaturated polyester resin, urea resin, melamine resin, alkyd resin, phenol resin, fluoroacrylic resin, acryl-styrene resin, silicone resin, and a modified silicone resin modified with a resin such as acrylic resin, polyester resin, epoxy resin, polyamide resin, polyamideimide resin, alkyd resin, urethane resin and fluororesin. In the present invention, acrylic resin, silicone resin, or a modified silicone resin is most preferably used.

In the ferrite carrier for an electrophotographic developer according to the present invention, the coating amount of the resin is preferably from 0.01 to 10 wt % based on the ferrite carrier core material. If the coating amount is less than 0.01 wt %, a uniform coating layer can be hardly formed on the carrier surface, whereas if the coating amount exceeds 10 wt %, aggregation of carrier particles with each other occurs to cause not only reduction in the productivity, such as reduction in the yield, but also variation of developer characteristics such as flowability or charge amount.

For the purpose of controlling the electric resistance, charge amount and charging rate of the carrier, an electrically conductive agent may be added to the coating resin. The electric resistance of the electrically conductive agent itself is low and therefore, when the amount added thereof is too large, rapid charge leakage is likely to occur. Accordingly, the amount added is from 0.1 to 20.0 wt %, preferably from 0.25 to 15.0 wt %, more preferably from 0.5 to 10.0 wt %, based on the solid content of the coating resin. The electrically conductive agent includes an electrically conductive carbon or carbon nanotube, an oxide such as titanium oxide and tin oxide, and various organic electrically conductive agents.

In addition, a charge control agent may be incorporated into the coating resin. Examples of the charge control agent include various charge control agents generally used for a toner, and various silane coupling agents. This is because in the case of controlling the exposed area of the core material to be relatively small by coating formation, the charge imparting ability sometimes decreases, but this can be controlled by the addition of various charge control agents or silane coupling agents. The kind of the usable charge control agent or silane coupling agent is not particularly limited, but a charge control agent such as nigrosine dye, quaternary ammonium salt, organometallic complex and metal-containing monoazo dye, an aminosilane coupling agent, a fluorine-based silane coupling agent, etc. are preferred.

<Production Methods of Ferrite Carrier Core Material for Electrophotographic Developer and Ferrite Carrier>

The production methods of the ferrite carrier core material for an electrophotographic developer and the ferrite carrier according to the present invention are described below.

In the production method of the ferrite carrier core material for an electrophotographic developer according to the present invention, the ferrite raw material is mixed/pulverized, mixed together with a binder and then granulated, and the granulated material obtained is subjected to preliminary sintering and then to sintering.

To describe one example of the preparation method of the ferrite raw material (granulated material), an appropriate amount of a ferrite composition composed of an Fe raw material and at least one raw material of Mn, Mg and Sr is weighted and wet pulverized by adding water to produce a slurry. The pulverized slurry produced is granulated by a spray drier and classified to prepare a granulated material having a predetermined particle diameter. Considering the particle diameter of the ferrite particle obtained, the particle diameter of the granulated material is preferably on the order of 5 to 30 μm. In another example of the preparation method, appropriate amounts of raw materials for a ferrite composition are weighed and mixed, respective raw materials are pulverized/dispersed by dry pulverization, and a mixture thereof is granulated by a granulator and classified to prepare a granulated material having a predetermined particle diameter.

Before the above-described granulation step, calcining may be performed. Specifically, an appropriately weighed amount of the raw material is dry pulverized, then pelletized (temporary granulation) using a pressure molding machine, etc. and calcined at 700 to 1,300° C. It may be also possible that without using a pressure molding machine, water is added after pulverization to make a slurry and the slurry is granulated (temporary granulation) using a spray drier. When a material subjected to calcining is used as the raw material, the surface property or magnetic characteristics of the finally finished ferrite particle can hardly vary among particles.

The granulated material prepared in this way is thermally sprayed in the air and thereby ferritized. For the thermal spraying, a combustion gas and oxygen are used as a combustible gas combustion flame, and the volume ratio of the combustion gas and oxygen is 1:3.5 to 1:6.0. If the ratio of oxygen to the combustion gas in the combustible gas combustion flame is less than 3.5, insufficient melting results, making it difficult to form a true spherical shape, and if the ratio of oxygen to the combustion gas exceeds 6.0, ferritization becomes difficult. Oxygen is used, for example, in a ratio of 35 to 60 Nm³/hr per 10 Nm³/hr of the combustion gas.

As the combustion gas used for thermal spraying, a propane gas, a propylene gas, an acetylene gas, etc. is used, and among others, a propane gas is suitably used. In addition, nitrogen, oxygen or air is used as the granulated material conveying gas. The flow velocity of the granulated material is preferably from 20 to 60 m/sec.

The ferrite particle thus ferritized by thermal spraying is rapidly cooled and solidified in water or air at room temperature and collected through a filter.

The ferrite particle recovered through the filter for collection is, if desired, classified to produce a ferrite carrier core material (ferrite particle). As the method for classification, the existing air classification, mesh filtration method, precipitation method or the like is used to adjust the particle size to a desired particle diameter. The particle may also be separated from particles having a large particle diameter by a cyclone, etc. and recovered.

In the case of sintering the particle in a tunnel-type electric furnace, the amount of the particle sintered by one sintering is made small and the particle is slowly sintered over time, whereby a relatively high degree of sphericity is likely to be obtained.

In order to more increase the degree of sphericity, sintering is preferably performed by the above-described thermal spray sintering method.

Furthermore, the surface is, if desired, subjected to an oxide coating treatment by heating at a low temperature, whereby the electric resistance can be adjusted In the surface coating treatment, a heat treatment is performed, for example, at 300 to 800° C., preferably from 450 to 700° C., by using a general rotary electric furnace, batch-type electric furnace or the like. In order to uniformly form an oxide coating on the core material particle, it is preferred to use a rotary electric furnace.

The ferrite carrier for an electrophotographic developer of the present invention is obtained by coating the surface of the above-described ferrite carrier core material with the above-described resin to form a resin coating. As the coating method, the coating can be performed by a known method, for example, a brush coating method, a spray dry system using a fluidized bed, a rotary dry system, and a dip-and-dry method using a universal agitator. In order to improve the coverage ratio, the method using a fluidized bed is preferred.

In the case where the resin after coating the ferrite carrier core material is baked, the baking may use either an external heating system or an internal heating system, and, for example, a fixed or fluidized electric furnace, a rotary electric furnace or a burner furnace may be used or baking with microwave may also be employed. In the case of using a UV-curable resin, a UV heater is used. The baking temperature varies depending on the resin used but must be a temperature not lower than the melting point or glass transition point, and for a thermosetting resin, a condensation-crosslinking resin, etc., the temperature needs to be raised to a temperature at which curing sufficiently proceeds.

<Electrophotographic Developer>

The electrophotographic developer according to the present invention is described below.

The electrophotographic developer according to the present invention is composed of the above-described ferrite carrier for an electrophotographic developer and a toner.

The toner particle constituting the electrophotographic developer of the present invention includes a pulverized toner particle produced by a pulverization method, and a polymerized toner particle produced by a polymerizing method. In the present invention, a toner particle obtained by either method can be used.

The pulverized toner particle can be obtained, for example, by sufficiently mixing a binder resin, a charge control agent and a coloring agent by a mixer such as Henschel mixer, then melt-kneading the mixture by a twin-screw extruder, etc., subjecting the extrudate to cooling, pulverization and classification, adding an external additive, and then mixing these by a mixer, etc.

The binder resin constituting the pulverized toner particle is not particularly limited but includes polystyrene, chloropolystyrene, a styrene-chlorostyrene copolymer, a styrene-acrylic acid ester copolymer, a styrene-methacrylic acid copolymer, a rosin-modified maleic acid resin, an epoxy resin, a polyester resin, a polyurethane resin, etc. These resins are used individually or as a mixture.

As the charge control agent, any charge control agent may be used. For example, the charge control agent for a positively chargeable toner includes a nigrosine-based dye, a quaternary ammonium salt, etc., and the charge control agent for a negatively chargeable toner includes a metal-containing monoazo dye, etc.

As the coloring agent (color material), conventionally known dyes and pigments can be used. For example, carbon black, Phthalocyanine Blue, Permanent Red, Chrome Yellow, and Phthalocyanine Green can be used. Furthermore, an external additive such as silica powder and titania may be added according to the toner particle so as to improve the flowability and aggregation resistance of the toner.

The polymerized toner particle is a toner particle produced by a known method such as suspension polymerization method, emulsion polymerization method, emulsion aggregation method, ester extension polymerization method and phase transition emulsification method. In the production of such a polymerized toner particle, for example, a coloring agent dispersion liquid obtained by dispersing a coloring agent in water by use of a surfactant, a polymerizable monomer, a surfactant and a polymerization initiator are mixed and stirred in an aqueous medium, thereby emulsifying and dispersing the polymerizable monomer in the aqueous medium, and after polymerizing the polymerizable monomer under stirring and mixing, a salting-out agent is added to salt out a polymer particle. The particle obtained by salting out is filtered, washed and dried, whereby a polymerized toner particle can be obtained. Thereafter, if desired, an external additive for imparting a function may also be added to the dried toner particle.

Furthermore, at the time of production of the polymerized toner particle, a fixability improving agent and a charge control agent may be blended, in addition to the polymerizable monomer, the surfactant, the polymerization initiator and the coloring agent. By this blending, various characteristics of the polymerized toner particle obtained can be controlled and improved. In addition, a chain transfer agent may also be used so as to improve the dispersibility of the polymerizable monomer in the aqueous medium and at the same time, adjust the molecular weight of the polymer obtained.

The polymerizable monomer used in the production of the polymerized toner particle is not particularly limited but includes, for example, styrene and a derivative thereof, ethylenically unsaturated monoolefins such as ethylene and propylene, vinyl halides such as vinyl chloride, vinyl esters such as vinyl acetate, and α-methylene aliphatic monocarboxylic acid esters such as methyl acrylate, ethyl acrylate, methyl methacrylate, ethyl methacrylate, 2-ethylhexyl methacrylate, dimethylamino acrylate and diethylamino methacrylate.

As the coloring agent (color material) used at the time of preparation of the polymerized toner particle, conventionally known dyes and pigments can be used. For example, carbon black, Phthalocyanine Blue, Permanent Red, Chrome Yellow and Phthalocyanine Green can be used. In addition, the surface of the coloring agent may be modified with a silane coupling agent, a titanium coupling agent, etc.

As the surfactant used in the production of the polymerized toner particle, an anionic surfactant, a cationic surfactant, an amphoteric surfactant and a nonionic surfactant may be used.

The anionic surfactant includes a fatty acid salt such as sodium oleate and castor oil, an alkylsulfuric acid ester such as sodium laurylsulfate and ammonium laurylsulfate, an alkylbenzenesulfonate such as sodium dodecylbenzenesulfonate, an alkylnaphthalenesulfonate, an alkylphosphoric ester salt, a naphthalenesulfonic acid-formalin condensate, a polyoxyethylenealkylsulfuric ester salt, etc. The nonionic surfactant includes a polyoxyethylene alkyl ether, a polyoxyethylene fatty acid ester, a sorbitan fatty acid ester, a polyoxyethylene alkylamine, glycerin, a fatty acid ester, an oxyethylene-oxypropylene block polymer, etc. The cationic surfactant includes, for example, an alkylamine salt such as laurylamine acetate, and a quaternary ammonium salt such as lauryltrimethylammonium chloride and stearyltrimethylammonium chloride. The amphoteric surfactant includes an aminocarboxylate, an alkylamino acid, etc.

The surfactant above may be used usually in an amount of 0.01 to 10 wt % based on the polymerizable monomer. Such a surfactant affects the dispersion stability of the monomer and at the same time, affects the environmental dependency of the polymerized toner particle obtained. Use of the surfactant in the range above is preferred from the standpoint of ensuring the dispersion stability of the monomer and reducing the environmental dependency of the polymerized toner particle.

In the production of the polymerized toner particle, a polymerization initiator is usually used. The polymerization initiator includes a water-soluble polymerization initiator and an oil-soluble polymerization initiator, and both can be used in the present invention. The water-soluble polymerization initiator that can be used in the present invention includes, for example, a persulfate such as potassium persulfate and ammonium persulfate, and a water-soluble peroxide compound. The oil-soluble polymerization initiator includes, for example, an azo compound such as azobisisobutyronitrile, and an oil-soluble peroxide compound.

In the case of using a chain transfer agent in the present invention, the chain transfer agent includes, for example, mercaptans such as octylmercaptan, dodecylmercaptan and tert-dodecylmercaptan, and carbon tetrabromide.

In the case where the polymerized toner particle used in the present invention contains a fixability improving agent, for example, a natural wax such as carnauba wax, and an olefinic wax such as polypropylene and polyethylene, may be used as the fixability improving agent.

In the case where the polymerized toner particle used in the present invention contains a charge control agent, the charge control agent used is not particularly limited and, for example, a nigrosine-based dye, a quaternary ammonium salt, an organic metal complex, and a metal-containing monoazo dye may be used.

The external additive used to enhance the flowability, etc. of the polymerized toner particle includes, for example, silica, titanium oxide, barium titanate, a fluororesin microparticle, and an acrylic resin microparticle. These additives may be used individually or in combination.

The salting-out agent used to separate the polymerized particle from the aqueous medium includes a metal salt such as magnesium sulfate, aluminum sulfate, barium chloride, magnesium chloride, calcium chloride and sodium chloride.

The volume average particle diameter of the toner particle produced as above is from 2 to 15 μm, preferably from 3 to 10 μm, and the polymerized toner particle is higher in the uniformity of particles than the pulverized toner particle. If the volume average particle diameter of the toner particle is less than 2 μm, the charging ability decreases to readily cause fogging or toner dusting, and if the volume average particle diameter exceeds 15 μm, deterioration of the image quality is caused.

An electrophotographic developer can be obtained by mixing the carrier and the toner produced as above. The mixing ratio of the carrier and the toner, i.e., the toner concentration, may be set to a high concentration of 15 wt % or more. When the toner is rapidly consumed as in a high-speed machine or a full-color machine, the toner replenishment cannot keep up with the consumption, and a trouble such as image density reduction or image unevenness is likely to occur. Accordingly, the toner concentration is set high so that an abrupt increase in the toner consumption can be responded. The specific surface area of the ferrite carrier for use in the present invention is very large as described above and therefore, the charge imparting ability can be maintained even at a high toner concentration.

The toner concentration as used herein a toner concentration of a developer existing in the development region. As to the developer for replenishment, many disclosures have been made on the toner concentration, but this is the toner concentration of a developer replenished, and the toner concentration in the developing machine is conventionally adjusted to about 10 wt %.

The carrier of the present invention can be used even when the toner concentration in the development region is less than 15 wt %, but the printing speed and the printing rate cannot be further increased as ever. If the toner concentration exceeds 35 wt %, it is difficult even for a carrier having a very high charging ability like the ferrite carrier used in the present invention to uniformly impart an electric charge to all toners.

The carrier of the present invention is used at a toner concentration in the development region of 15 wt % or more, preferably from 15 to 35 wt %, more preferably from 15 to 25 wt %.

The electrophotographic developer according to the present invention prepared as above can be used in a copying machine, a printer, FAX, a printing machine, etc., of a digital type employing a development system where an electrostatic latent image formed on a latent image holding member having an organic photoconductor layer is reversely developed with a magnetic brush of a two-component developer containing a toner and a carrier while applying a bias electric field.

The electrophotographic developer can also be applied to a full-color machine, etc. using an alternating electric field, where when applying a development bias from a magnetic brush to an electrostatic latent image side, an AC bias is superimposed on a DC bias.

In addition, the electrophotographic developer may also be used as an auxiliary charging member for charging the toner, in the conventional one-component development system using no carrier.

In this case, because of having another member for charging the toner, the carrier of the present invention is used to play an auxiliary role in charging the toner. Therefore, the effect is exerted even when the toner concentration exceeds 35 wt %.

The present invention is specifically described below based on Examples and the like.

### EXAMPLES

### Example 1

Raw materials were weighed to afford 39.6 mol % of MnO, 9.6 mol % of MgO, 50 mol % of Fe₂O₃ and 0.8 mol % of SrO and pulverized for 4.5 hours by a dry media mill (vibration mill, stainless steel beads of ⅛ inch in diameter). The pulverized material obtained was formed into an about 1 mm-square pellet by a roller compactor. Trimanganese tetroxide, magnesium hydroxide and strontium carbonate were used as the MnO raw material, MgO raw material and SrO raw material, respectively. The pellet was sieved through a vibration sieve with an opening size of 3 mm to remove a coarse powder and then through a vibration sieve with an opening size of 0.5 mm to remove a fine powder, heated at 950° C. for 3 hours to perform calcining, and pulverized to an average particle diameter of about 4 μm by using a dry media mill (vibration mill, stainless steel beads of ⅛ inch in diameter). Subsequently, water was added and after further adding a polycarboxylic acid-based dispersant, a polyether-based defoaming agent and polyvinyl alcohol (10% solution) as a binder, the mixture was pulverized for 6 hours by using a wet media mill (vertical bead mill, zirconia beads of 1 mm in diameter). The resulting slurry was measured for the particle diameter (primary particle diameter of pulverization) by Microtrac, as a result, the volume average particle size was 1.8 μm. The slurry was then granulated by a spray drier and dried, and the particle size of the obtained particle (granulated material) was adjusted to afford a volume average particle diameter of approximately from 10 to 20 μm after calcining. The apparent density of the granulated material obtained was 1.1 g/cm³.

The granulated material obtained was held for 3 hours at a preset temperature of 1,050° C. to perform preliminary sintering in an air atmosphere by using a pusher-type sintering furnace. The apparent density of the powder obtained after preliminary sintering was 1.73 g/cm³.

Sintering was performed by a method where the preliminarily sintered material obtained is passed through flame to which 8 Nm³/hr of propane and 32 Nm³/hr of oxygen are supplied under the condition of a supply rate of 60 kg/hr, and the material was rapidly cooled in air to obtain a sintered material. Incidentally, the preliminarily sintered material was fed to the flame by means of pneumatic transportation using an oxygen gas, and the supply rate of oxygen gas was set to 10 Nm³/hr. The sintered material obtained was classified using an air classifier and sieve classifier, then heated at a preset temperature of 550° C. by means of a rotary kiln to adjust the magnetization and electric resistance by allowing the oxidation of the particle surface to proceed, and finally subjected to magnetic separation to obtain a ferrite particle (ferrite carrier core material).

### Example 2

After performing sintering in the same manner as in Example 1, the sintered material was classified by changing the condition of the pneumatic classifier to adjust the particle size distribution, then heated at a preset temperature of 600° C. by means of a rotary kiln to adjust the magnetization and electric resistance by allowing the oxidation of the particle surface to proceed, and finally subjected to magnetic separation to obtain a ferrite particle (ferrite carrier core material).

### Example 3

After performing sintering in the same manner as in Example 1, the sintered material was classified by changing the condition of the pneumatic classifier to adjust the particle size distribution and without conducting a heat treatment in a rotary kiln, subjected to magnetic separation to obtain a ferrite particle (ferrite carrier core material).

### Comparative Example 1

A ferrite particle (ferrite carrier core material) was obtained in the same manner as in Example 1 except that in the production method of Example 1, the particle size of the obtained particle (granulated material) was adjusted to afford a volume average particle diameter of approximately from 30 to 40 μm after calcining and the sintering after preliminary sintering was performed in a tunnel-type electric furnace. In the sintering, the sintering was performed at a preset temperature of 1,250° C. for 6 hours while flowing a gas adjusted to an oxygen concentration of 1.3 vol %.

### Comparative Example 2

A ferrite particle was obtained in the same manner as in Comparative Example 1 except that the temperature of the sintering was set to 1,090° C. The obtained ferrite particle was a porous ferrite particle due to sintering at a low temperature.

100 Parts by weight of the obtained ferrite particle and a condensation-crosslinking silicone resin (weight average molecular weight: about 8,000) composed of a T unit and a D unit were prepared, and 30 parts by weight of a solution of this silicone resin (6 parts by weight in terms of solid content because the resin solution concentration is 20%, diluting solvent: toluene) was mixed and stirred at 60° C. under reduced pressure of 2.3 kPa, thereby impregnating the resin into the inside of the porous ferrite particle while volatilizing toluene.

After almost completely removing the toluene, the residue was taken out of the apparatus and put in a vessel. The vessel was placed in an oven of a hot air heating type, and a heating treatment was performed at 200° C. for 2 hours. Thereafter, the product was cooled to room temperature, and a ferrite particle with the resin being cured was taken out and disaggregated from aggregation of particles by using a vibrating sieve. The non-magnetic material was removed by means of a magnetic separator and then, coarse particles were removed by again using the vibrating sieve to obtain a carrier core material having hybridized therein a resin and a ferrite in which a silicone resin is permeated into a porous ferrite particle.

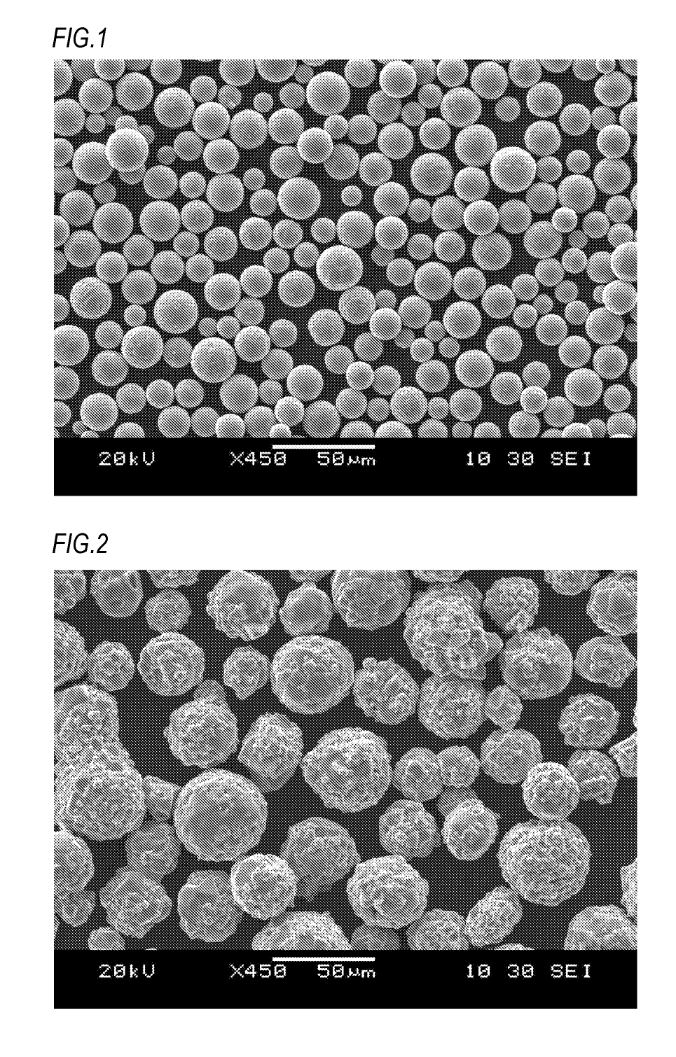

The characteristics (volume average particle diameter, number average particle diameter, particle density, apparent density, specific surface area by air permeability method, shape factor SF-1, shape factor SF-2, and magnetization) of each of the ferrite carrier core materials of Examples 1 to 3 and Comparative Examples 1 and 2 (in Comparative Example 2, a carrier core material having hybridized therein a resin and a ferrite in which a silicone resin is permeated into a porous ferrite particle) are shown in Table 1. The measurement methods for the particle density, apparent density, specific surface area by air permeability method, and magnetization are as follows, and other measurement methods are as described above. FIGS. 1 and 2 show electron micrographs (secondary electron image, ×450) of the carrier core materials of Example 1 and Comparative Example 1, respectively.

[Particle Density]

The particle density was measured by means of a picnometer in conformity with JIS R9301-2-1. The measurement was performed at a temperature of 25° C. by using methanol as the solvent.

[Apparent Density]

The apparent density was measured in conformity with JIS Z 2504. Details are as follows.

1. Apparatus

A powder apparent density meter consisting of a funnel, a cup, a funnel supporter, a supporting rod and a supporting base is used, and a balance having a weighing capacity of 200 g and a weighing sensitivity of 50 mg is used.

2. Measurement Method

(1) A sample weighs at least 150 g or more.

(2) The sample is poured into the funnel having an orifice with a hole diameter of 2.5+0.2/−0 mm until the sample poured and outflowed fills the cup and spills out.

(3) Pouring of the sample is stopped immediately upon start of spilling out, and the sample heaped above the cup is scraped flat with a spatula along the top edge of the cup while taking care not to apply vibration.

(4) The side of the cup is lightly tapped to settle the sample and after removing the sample attached to the outside of the cup, the weight of the sample in the cup is weighed to a precision of 0.05 g.

3. Calculation

A value obtained by multiplying the measured value obtained in the item 2-(4) by 0.04 is rounded to the second decimal place according to JIS-Z8401 (method for rounding a numerical value), and this value is defined as the apparent density in the unit of “g/cm³”.

[Specific Surface Area by Air Permeation Method]

A sample after filling a plastic-made sample tube was measured for the specific surface area by air permeability method using a powder specific surface area measuring apparatus (Model SS-100, manufactured by Shimadzu Corporation). More specifically, the filling method and measurement procedure of the sample are as follows.

(1) Sample Filling

A sieve plate was put in a plastic-made sample tube, and one sheet of filter paper was further laid thereon. In this state, the sample tube was set on a tapping stand of a powder tester (manufactured by Hosokawa Micron Corporation), and the sample was poured up to about ⅓ of the sample tube. The sample tube was tapped for 60 seconds by operating the powder tester and after tapping, the sample was additionally poured up to about ⅔ of the sample tube, and the sample tube was again tapped for 60 seconds by operating the powder tester. Thereafter, the sample was additionally pored until filling the sample tube, and the sample tube was tapped for 60 seconds by operating the powder tester. After the completion of third tapping, the excess sample attached to the sample tube was removed by means of a brush, a wiper, etc., whereby the sample filling was completed.

(2) Measurement of Specific Surface Area

Petrolatum was applied to the lower part of the sample tube and after connecting this portion to a measurement tube, pure water was poured into the measurement tube. Subsequently, a cock at the outflow port in the lower part of the measurement apparatus was opened to flow out the pure water from the measurement tube, and the time t until the water level in the measurement tube lowers by a 20 cc portion was measured. The time t (sec) required until 20 cc of air passes through the sample-filled layer, obtained from the measured time above, and the weight W (g) of the sample filling the inside of the sample tube were substituted into the Kozeny-Carman's equation (see, the following equation (1)) to determined the specific surface area Sw of the sample.

$$\begin{matrix}[ Expression 4 ] & \\ Sw = \frac{14}{ρ} \sqrt{\frac{Δ PAt}{η LQ} \times \frac{{ɛ}^{3}}{{( 1 - ɛ )}^{2}}} & ( 1 )\end{matrix}$$

In the equation (1), E is the void ratio of the sample-filled layer determined according to the following equation (2):

$$\begin{matrix}[ Expression 5 ] & \\ ɛ = 1 - \frac{W}{ρ AL} & ( 2 )\end{matrix}$$

In equations (1) and (2), other symbols have the following meanings.

Specific surface area of sample: Sw (cm²/g)

Density of sample: ρ (g/cm³)

Viscosity coefficient of air: η (g/cm·sec)

Thickness of sample-filled layer: L (cm)

Volume of air passed through sample-filled layer: Q (cc)

Pressure difference between both ends of sample-filled layer: ΔP (g/cm²)

Cross-sectional area of sample-filled layer: A (cm²)

In the present invention, the sample was measured at room temperature of 22° C., and the values used as constants and control settings of equations (1) and (2) are as follows.

Density ρ of sample: 5 (g/cm³)

Viscosity coefficient η of air: 0.000182 (g/cm·sec)

Thickness L of sample-filled layer: 14.5 (cm)

Volume Q of air passed through sample-filled layer: 20 (cc)

Pressure difference ΔP between both ends of sample-filled layer: 10 (g/cm²)

Cross-sectional area A of sample-filled layer: 2.024 (cm²)

[Magnetic Properties]

The magnetization was measured using an integral-type B-H tracer Model BHU-60 (manufactured by Riken Denshi Co., Ltd.). An H coil for measuring magnetic field and a 4πI coil for measuring magnetization are inserted between electromagnets. In this case, the sample is placed in the 4πI coil. The outputs from each of the H coil and the 4πI coil when the magnetic field H is changed by varying the current of the electromagnets are integrated, and a hysteresis loop is depicted on recording paper with the H output on the X-axis and the 4πI coil output on the Y-axis. Here, the sample was measured under the measurement conditions that the sample filling quantity is about 1 g, the sample filling cell has an inner diameter of 7 mm φ±0.02 mm and a height of 10 mm±0.1 mm, and the number of turns of 4πI coil is 30. This magnetization is a measured value when a magnetic field of 3K·1000/4π·A/m is applied.

TABLE 1
Magnetic Properties

| | Volume | Number | | | Specific | | | |
|---|---|---|---|---|---|---|---|---|
| | Average | Average | | | Surface Area | | | |
| | Particle | Particle | Particle | Apparent | by Air | Shape | Shape | |
| | Diameter | Diameter | Density | Density | Permeability | Factor | Factor | Magnetization*1 |
| | (μm) | (μm) | (g/cm³) | (g/cm³) | Method (cm²/g) | SF-1 | SF-2 | (Am²/kg) |
| Example 1 | 15.9 | 13.2 | 4.81 | 2.49 | 832 | 112 | 110 | 68 |
| Example 2 | 13.1 | 10.1 | 4.77 | 2.37 | 865 | 109 | 108 | 64 |
| Example 3 | 18.3 | 15.4 | 4.83 | 2.46 | 796 | 110 | 109 | 71 |
| Comparative | 35.8 | 30.4 | 4.79 | 2.15 | 481 | 122 | 118 | 70 |
| Example 1 | | | | | | | | |
| Comparative | 38.4 | 32.6 | 4.22 | 1.85 | 537 | 118 | 124 | 62 |
| Example 2 | | | | | | | | |

*1:3K · 1000/4π · A/m

As apparent from Table 1, in the ferrite carrier core materials (ferrite particles) of Examples 1 to 3, the shape factor SF-1 and shape factor SF-2 are in the desired ranges, the shape is truly spherical, and the particle has a good shape with little surface unevenness. These results are evidenced also from FIG. 1 that is an electron micrograph of the ferrite carrier core material of Example 1.

On the other hand, in the ferrite core materials (ferrite particles) of Comparative Examples 1 and 2, the apparent density and specific surface area are small and the shape factor SF-1 and shape factor SF-2 also show a large value. These results are evidenced also from FIG. 2 that is an electron micrograph of the ferrite carrier core material of Comparative Example 1.

### Example 4

An acrylic resin solution was produced by dissolving 50 g of acrylic resin (BR-52, produced by Mitsubishi Rayon Co., Ltd.) in 400 cc of toluene. 10 kg of the ferrite particle (ferrite carrier core material) obtained in Example 1 was put in a stirring/mixing apparatus at a preset temperature of 60° C. and coated with the resin solution above under stirring and heating to cover the core material particle while volatilizing toluene in the air. After almost completely volatilizing the toluene, the residue was taken out of the mixing apparatus and heated in an oven-type heating apparatus at a preset temperature of 150° C. for 2 hours. Thereafter, the product was cooled to room temperature, and a ferrite particle coated with a resin was taken out and disaggregated from aggregation of particles by using a vibrating sieve. The non-magnetic material was removed by means of a magnetic separator and then, coarse particles were removed by again using the vibrating sieve to obtain a resin-coated ferrite particle (ferrite carrier). The resin coating amount was 0.5 wt % based on the ferrite carrier core material.

### Example 5

A resin-coated ferrite particle (ferrite carrier) was obtained in the same manner as in Example 4 except that the ferrite particle obtained in Example 2 was used.

### Example 6

A resin-coated ferrite particle (ferrite carrier) was obtained in the same manner as in Example 4 except that the ferrite particle obtained in Example 3 was used.

### Example 7

A resin-coated ferrite particle (ferrite carrier) was obtained in the same manner as in Example 4 except that 1.25 g of γ-aminopropyltriethoxysilane was added to the acrylic resin solution.

### Example 8

A resin-coated ferrite particle (ferrite carrier) was obtained in the same manner as in Example 7 except that 2.5 g of γ-aminopropyltriethoxysilane was added to the acrylic resin solution.

### Comparative Example 3

A resin-coated ferrite particle (ferrite carrier) was obtained in the same manner as in Example 4 except that the ferrite particle obtained in Comparative Example 1 was used.

### Comparative Example 4

A resin-coated ferrite particle (ferrite carrier) was obtained by coating the ferrite particle prepared in Comparative Example 2 with an acrylic resin in the same manner as in Example 4.

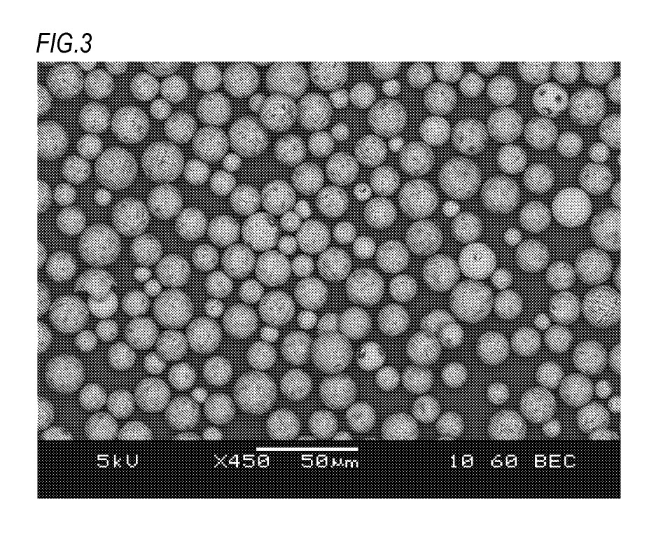

The characteristics (ferrite carrier core material used, volume average particle diameter, number average particle diameter, particle density, apparent density, specific surface area by air permeability method, charge amount and charge amount ratio) of each of the ferrite carriers (resin-coated ferrite particles) of Examples 4 to 8 and Comparative Examples 3 and 4 are shown in Table 2. The measurement methods for the charge amount and charge amount ratio are as follows, and other measurement methods are as described above. FIG. 3 shows an electron micrograph (secondary electron image, ×450) of the ferrite carrier of Example 4.

[Charge Amount]

The charge amount was determined by measuring a mixture of carrier and toner by means of a suction-type charge measuring apparatus (Epping q/m-meter, manufactured by PES-Laboratoriumu). As the toner, a commercially available negative toner employed in a full-color printer (cyan toner for DocuPrint C3530, produced by Fuji Xerox Co., Ltd.; average particle diameter: about 5.8 μm) was used, and developers in an amount of 10 g were prepared to have a toner concentration of 10 wt %, 15 wt % an 20 wt %. Each of the developers prepared was put in a 50 cc glass bottle, and the glass bottle was housed and fixed in a cylindrical holder of 130 mm in diameter and 200 mm in height. The developer was stirred for 30 minutes on a Turbula mixer manufactured by Shinmaru Enterprises Corp., and the charge amount was measured using a 635M screen.

[Charge Amount Ratio]

The charge amount ratio was calculated according to the following equations.

$$\begin{matrix}[ Expression 6 ] & \\ Charge amount ratio 1 = \frac{\begin{matrix}Charge amount at toner \\ concentration of 15 wt \%\end{matrix}}{\begin{matrix}Charge amount at toner \\ concentration of 10 wt \%\end{matrix}} \times 100 \\ Charge amount ratio 2 = \frac{\begin{matrix}Charge amount at toner \\ concentration of 20 wt \%\end{matrix}}{\begin{matrix}Charge amount at toner \\ concentration of 10 wt \%\end{matrix}} \times 100 & \end{matrix}$$

TABLE 2

| | | | | | | Specific | | | | | |
|---|---|---|---|---|---|---|---|---|---|---|---|
| | | | | | | Surface | | | | | |
| | | Volume | Number | | | Area | Charge Amount (μC/g) | | | Charge Amount | |
| | Ferrite | Average | Average | | | by Air | At toner | At toner | At toner | Ratio | |
| | Carrier | Particle | Particle | Particle | Apparent | Permeability | concen- | concen- | concen- | Charge | Charge |
| | Core | Diameter | Diameter | Density | Density | Method | tration of | tration of | tration of | Amount | Amount |
| | Material | (μm) | (μm) | (g/cm³) | (g/cm³) | (cm²/g) | 10% | 15% | 20% | Ratio 1*² | Ratio 2*³ |
| Example 4 | Example 1 | 16.9 | 14.1 | 4.75 | 2.36 | 836 | 45.1 | 39.8 | 32.9 | 88% | 73% |
| Example 5 | Example 2 | 13.6 | 10.3 | 4.73 | 2.34 | 861 | 41.1 | 36.1 | 30.8 | 88% | 75% |
| Example 6 | Example 3 | 19.1 | 16.8 | 4.81 | 2.43 | 768 | 47.3 | 42.2 | 34.5 | 89% | 73% |
| Example 7 | Example 1 | 17.5 | 15.7 | 4.75 | 2.36 | 833 | 50.2 | 42.9 | 37.3 | 85% | 74% |
| Example 8 | Example 1 | 18.1 | 15.2 | 4.76 | 2.37 | 818 | 55.3 | 47.4 | 40.8 | 86% | 74% |
| Comparative | Comparative | 36.2 | 33.2 | 4.79 | 2.04 | 490 | 57.2 | 38.4 | 22.9 | 67% | 40% |
| Example 3 | Example 1 | | | | | | | | | | |
| Comparative | Comparative | 40.8 | 35.4 | 4.03 | 1.82 | 501 | 36.1 | 24.7 | 14.1 | 68% | 39% |
| Example 4 | Example 2 | | | | | | | | | | |

*²Charge amount ratio 1 = [(charge amount at toner concentration of 15 wt %/charge amount at toner concentration of 10 wt %) × 100]
*³Charge amount ratio 2 = [(charge amount at toner concentration of 20 wt %/charge amount at toner concentration of 10 wt %) × 100]

As apparent from FIG. 3, the ferrite carrier of Example 4 that is a resin-coated carrier using the ferrite carrier core material of Example 1 had a true spherical shape, similarly to the ferrite carrier core material of Example 1.

In addition, as understood from the results in Table 2, all of the ferrite carriers of Examples 4 to 8 have good charging characteristics. First, the charge amount at a toner concentration of 10 wt % shows a high value exceeding 40 μC/g. Secondly, even when the toner concentration is increased to 15 wt % and 20 wt %, an extreme reduction in the charge amount does not occur. It is evidenced also by the charge amount ratio that a charging capacity of 70% or more based on the charge amount at a toner concentration of 10% is maintained.

On the other hand, in the ferrite carriers of Comparative Examples 3 and 4, the ratio of the charge amount at a toner concentration of 15 wt % was 70% or less based on that at 10 wt % and as to the charge amount at a toner concentration of 20 wt %, the ratio to that at 10 wt % was decreased to about 40%.

The ferrite carriers of Examples 4 to 8 have a very high specific surface area due to a very small particle diameter and afford a large area for charging the toner. In addition, as seen from the electron micrograph of FIG. 3 and the shape factor SF-1 and shape factor SF-2 of the ferrite carrier core material, the particle has a high degree of sphericity, affording a shape close to a true sphere, and has little surface unevenness and therefore, despite a very small particle diameter, its mixing property with a toner is good. It is considered that for these reasons, the above-described good charging characteristics are obtained.

### INDUSTRIAL APPLICABILITY

In the ferrite carrier core material for an electrophotographic developer according to the present invention, a ferrite particle having a very small average particle diameter and having a true spherical shape with little surface unevenness is used, so that when a ferrite carrier obtained by coating the surface of the ferrite carrier core material with a resin is formed into a developer together with a toner, the charge imparting ability is excellent even at a high toner concentration and because of high flowability, the mixing property with a toner is good.

Accordingly, the present invention can be widely used particularly in the field of a full-color machine requiring high image quality and a high-speed machine requiring reliability and durability in image preservation.

What is claimed is:

1. A ferrite carrier core material for an electrophotographic developer, the ferrite carrier core material comprising ferrite particles,
wherein a volume average particle diameter of the ferrite particles is from 10 μm to less than 20 μm.

2. The ferrite carrier core material according to claim 1,
wherein a shape factor SF-1 of the ferrite particles is from 100 to 120.

3. The ferrite carrier core material according to claim 1,
wherein a shape factor SF-2 of the ferrite particles is from 100 to 120.

4. A ferrite carrier for an electrophotographic developer, the ferrite carrier comprising:
the ferrite carrier core material according to claim 1; and
a resin coating a surface of the ferrite carrier core material.

5. The ferrite carrier according to claim 4,
wherein a shape factor SF-1 of the ferrite particles is from 100 to 120.

6. The ferrite carrier according to claim 4,
wherein a shape factor SF-2 of the ferrite particles is from 100 to 120.

7. An electrophotographic developer comprising:
the ferrite carrier according to claim 4 and
a toner,
wherein a concentration of the toner is from 15 to 35 wt %.

8. The electrophotographic developer according to claim 7,
wherein a shape factor SF-1 of the ferrite particles is from 100 to 120.

9. The electrophotographic developer according to claim 7,
wherein a shape factor SF-2 of the ferrite particles is from 100 to 120.
